(19) United States
(12) Patent Application Publication
(10) Pub. No.: US 2021/0242556 A1
(43) Pub. Date: Aug. 5, 2021

(54) HIGH-FREQUENCY PASSIVE COMPONENT

(71) Applicant: Fujikura Ltd., Tokyo (JP)

(72) Inventors: Osamu Nukaga, Sakura-shi (JP); Masaru Bunya, Sakura-shi (JP); Lei Xu, Sakura-shi (JP)

(73) Assignee: Fujikura Ltd., Tokyo (JP)

(21) Appl. No.: 17/255,675

(22) PCT Filed: Jun. 27, 2019
(86) PCT No.: PCT/JP2019/025527

§ 371 Date: Dec. 23, 2020

(30) Foreign Application Priority Data
Jun. 28, 2018 (JP) 2018-123211
Jun. 18, 2019 (JP) 2019-112855

(51) Int. Cl. H01P 3/16; H04B 3/52

(52) U.S. Cl. CPC H01P 3/16; H04B 3/52

(57) ABSTRACT

A high-frequency passive component includes a substrate formed of a dielectric material including a waveguide region, a waveguide structure in which a first wide wall, a second wide wall, and a plurality of penetrating electrodes are arranged so as to surround the waveguide region, a first dielectric layer located outside the first wide wall, a second dielectric layer formed on the first wide wall, and an upper conductor layer. The upper conductor layer is formed over the first dielectric layer, the substrate between the first dielectric layer and the first wide wall, and the first wide wall.

### TECHNICAL FIELD

The present invention relates to high-frequency passive components.

The present application claims priority based on Japanese Patent Application No. 2018-123211 filed in Japan on Jun. 28, 2018 and Japanese Patent Application No. 2019-112855 filed in Japan on Jun. 18, 2019, the contents of which are incorporated herein by reference.

### BACKGROUND ART

In recent years, high-speed, large-capacity communication of several G [bps] using the millimeter wave band has been proposed, and a portion thereof has been realized. As a mode for realizing a small and inexpensive millimeter-wave communication module, for example, Patent Document 1 proposes a mode converter using a post-wall waveguide.

### PRIOR ART

### Patent Document

[Patent Document 1] Japanese Unexamined Patent Application, First Publication No. 2014-158243

### DISCLOSURE OF INVENTION

### Problems to be Solved by the Invention

The wide wall of the waveguide structure has a large area of a conductor layer. Therefore, when the dielectric layer is formed on the wide wall, the wide wall may be separated from the substrate. In particular, this problem becomes remarkable when a material having a higher high-frequency characteristic than the adhesion to the wiring layer is preferentially selected as the substrate.

The present invention has been made in view of the above circumstances, and the present invention is to provide a high-frequency passive component that can suppress the wide wall from peeling off from the substrate.

### Means for Solving the Problems

In order to solve the above-described problems, a high-frequency passive component according to an aspect of the present application includes a substrate formed of a dielectric material comprising a waveguide region; a waveguide structure including a first wide wall formed on a first surface of the substrate, a second wide wall formed on a second surface of the substrate, and a plurality of penetrating electrodes connected to both of the first and second wide walls, wherein the first wide wall, the second wide wall, and the plurality of penetrating electrodes are arranged so as to surround the waveguide region; a first dielectric layer formed on the first surface and located outside the first wide wall; a second dielectric layer formed on the first wide wall; and an upper conductor layer, where the upper conductor layer is formed over the first dielectric layer, the substrate between the first dielectric layer and the first wide wall, and the first wide wall.

In the high-frequency passive component according to the above-described aspect, the upper conductor layer may be formed over the first dielectric layer, the substrate between the first dielectric layer and the first wide wall, the first wide wall, and the second dielectric layer.

In addition, the upper conductor layer may be arranged at least at a corner portion of an outer peripheral portion of the first wide wall.

The upper conductor layer may be arranged on the entire outer peripheral portion of the first wide wall.

The substrate may be formed of glass, and the first dielectric layer and the second dielectric layer may be formed of resin.

At least a portion of the upper conductor layer may be sealed with a resin.

In addition, the high-frequency passive component according to the above-described aspect may include a penetrating structure including penetrating electrodes penetrating both surfaces of the substrate at a position different from the waveguide structure, a third dielectric layer formed on the substrate apart from the penetrating structure, and a connection conductor layer, where the connection conductor layer may be formed over the penetrating structure, on the substrate between the penetrating structure and the third dielectric layer, and the third dielectric layer.

Furthermore, a first dielectric layer located outside the second wide wall and an upper conductor layer may be formed on the second surface, and the upper conductor layer may be formed over the first dielectric layer, the substrate between the first dielectric layer and the second wide wall, and the second wide wall.

A contact portion and a separation portion may be formed at an end portion of the first wide wall in a location where the upper conductor layer covers the substrate between the first dielectric layer and the first wide wall and the end portion of the first wide wall, the separation portion may be separated from the substrate, and the contact portion may be in contact with the substrate and may be located outside the separation portion.

A contact portion, a separation portion, and a recess portion may be formed at the end portion of the first wide wall in a location where the upper conductor layer covers the substrate between the first dielectric layer and the first wide wall and the end portion of the first wide wall, the separation portion may be separated from the substrate, the contact portion may contact the substrate, and the recess portion is located between the separation portion and the contact portion, may be recessed toward an inside of the first wide wall, and the upper conductor layer may enter an inside of the recess portion.

### Effects of the Invention

According to the high-frequency passive component of the above-described aspects of the present invention, by devising the arrangement of the dielectric layer and the upper conductor layer on the substrate having the waveguide structure, it is possible to suppress the wide wall from peeling off from the substrate.

### BRIEF DESCRIPTION OF THE DRAWINGS

FIG. 1 is a perspective view which shows the external appearance of a high-frequency passive component.

FIG. 2 is a cross-sectional view which shows the high-frequency passive component of the first Embodiment.

FIG. 3 is a cross-sectional view which shows the high-frequency passive component of the second Embodiment.

FIG. 4 is a cross-sectional view which shows the high-frequency passive component of the third Embodiment.

FIG. 5 is a cross-sectional view which shows the high-frequency passive component of fourth Embodiment.

FIG. 6 is a cross-sectional view which shows the high-frequency passive component of fifth Embodiment.

FIG. 7 is a cross-sectional view which shows the high-frequency passive component of the sixth Embodiment.

FIG. 8 is a cross-sectional view which shows the high-frequency passive component of the seventh Embodiment.

FIG. 9 is a cross-sectional view which shows the high-frequency passive component of the eighth Embodiment.

FIG. 10 is a cross-sectional view which shows the high-frequency passive component of the ninth Embodiment.

FIG. 11 is a cross-sectional view which shows the high-frequency passive component of the tenth Embodiment.

FIG. 12 is a cross-sectional view which shows the high-frequency passive component of the eleventh Embodiment.

FIG. 13 is a cross-sectional view which shows the high-frequency passive component of the twelfth Embodiment.

FIG. 14 is a cross-sectional view which shows the high-frequency passive component of the thirteenth Embodiment.

FIG. 15 is a cross-sectional view which shows the high-frequency passive component of the fourteenth Embodiment.

FIG. 16 is a cross-sectional view which shows the high-frequency passive component of the fifteenth Embodiment.

FIG. 17 is an enlarged view of the A section of FIG. 2.

FIG. 18 is a drawing which shows the first modification example of FIG. 17.

FIG. 19 is a drawing which shows the second modification example of FIG. 17.

FIG. 20 is a drawing which shows the third modification example of FIG. 17.

FIG. 21 is a drawing which shows the fourth modification example of FIG. 17.

FIG. 22 is a drawing which shows the fifth modification example of FIG. 17.

FIG. 23 is a drawing which shows the sixth modification example of FIG. 17.

FIG. 24 is a drawing which shows the seventh modification example of FIG. 17.

FIG. 25 is a drawing which shows the eighth modification example of FIG. 17.

FIG. 26 is a drawing which shows the ninth modification example of FIG. 17.

FIG. 27 is a drawing which shows the tenth modification example of FIG. 17.

FIG. 28 is a drawing which shows the eleventh modification example of FIG. 17.

### EMBODIMENTS FOR CARRYING OUT THE INVENTION

Hereinafter, the present invention will be described based on preferred embodiments with reference to the drawings.

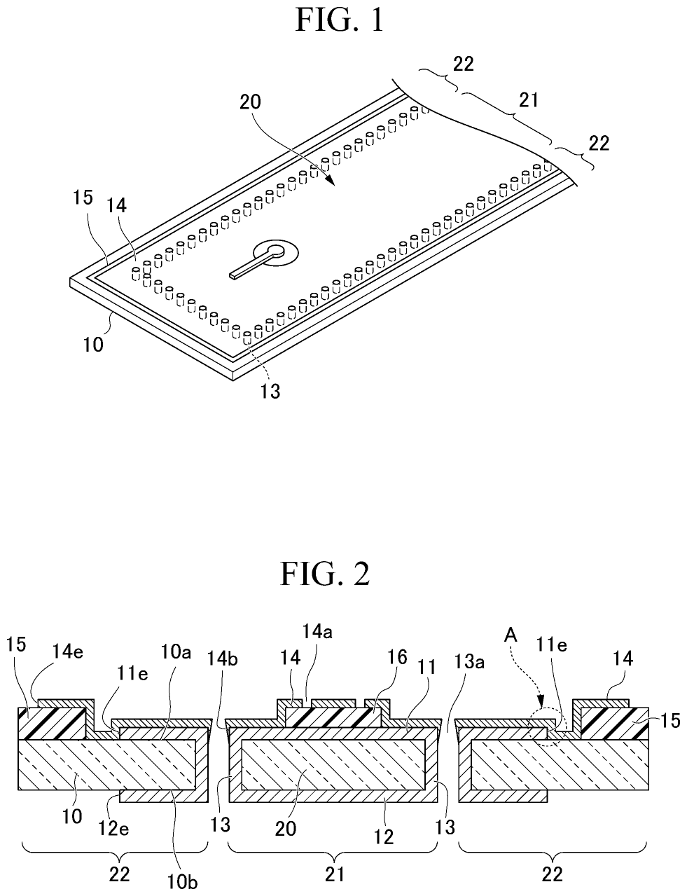

FIG. 1 shows the appearance of the high-frequency passive component. In this high-frequency passive component, the waveguide structure 21 is formed on the substrate 10. Examples of the substrate 10 include a glass substrate, a sapphire substrate, a dielectric substrate such as a quartz substrate, a single crystal substrate, and a composite substrate. The waveguide structure 21 can be used as a waveguide structure of a high-frequency device in which a high-frequency signal (electromagnetic wave) such as a millimeter wave is propagated. The frequency is not particularly limited; however, examples thereof include 30 to 300 GHz and 60 to 80 GHz. The substrate is preferably formed of a material having excellent high-frequency characteristics such as a small dielectric loss tangent. A specific example of the cross-sectional structure of the high-frequency passive component will be described below.

### First Embodiment

FIG. 2 shows a cross-sectional structure of a high-frequency passive component according to the first embodiment. The substrate 10 has a first surface 10a and a second surface 10b. In the present specification, the thickness direction of the substrate 10 is simply referred to as “thickness direction”, and the cross section along the thickness direction is simply referred to as “cross section”. In addition, in the thickness direction, a side of the first surface 10a is referred to as an upper side and the side of the second surface 10b is referred to as a lower side. A first wide wall 11 is formed on the first surface 10a, and a second wide wall 12 is formed on the second surface 10b.

The substrate 10 is formed of a dielectric material such as glass and includes the waveguide region 20 of the waveguide structure 21. The waveguide structure 21 includes a first wide wall 11, a second wide wall 12, and a plurality of penetrating electrodes 13, and the first wide wall 11, the second wide wall 12, and the plurality of penetrating electrodes 13 are arranged so as to surround a waveguide region 20. The plurality of penetrating electrodes 13 are connected to the first wide wall 11 and the second wide wall 12. The waveguide region 20 functions as a path along which a high-frequency signal propagates. The waveguide structure 21 may form passive components (passive devices) such as a waveguide, a filter, a diplexer, a directional coupler, and a distributor.

Both surfaces (first surface 10a and second surface 10b) of the substrate 10 on which the wide walls 11 and 12 are formed to oppose each other in the thickness direction. The wide walls 11 and 12 can be composed of, for example, a conductor layer such as a metal thin film. The wide walls 11 and 12 may be connected to a ground potential (not shown). The penetrating electrode 13 is provided on the inner wall of the through hole 13a formed in the substrate 10. The penetrating electrode 13 may be formed to be hollow inside the through hole 13a, or the inside of the through hole 13a may be solidly filled.

The waveguide structure 21 may include the wide walls 11 and 12 at least in contact with the waveguide region 20 and the penetrating electrode 13. The region 22 outside the waveguide structure 21 is the region outside the waveguide region 20 in the substrate 10. As shown in FIG. 2, the wide walls 11, 12 may be extended to the region 22.

As shown in FIG. 1, for example, by arranging a large number of penetrating electrodes 13, a wall portion surrounding the waveguide region 20 can be formed. Examples of the wall portion formed of the penetrating electrode 13 include a narrow wall facing the width direction of the waveguide structure 21, a short wall provided at an end portion in the longitudinal direction, and other side walls. The shape of the penetrating electrode 13 that constitutes the wall portion is not limited to the conductor column (post) having a columnar shape as shown in FIG. 1. For example, a continuous shape along the wall portion, a continuous shape along the corner portion, or the like can be employed. In addition, the arrangement of the penetrating electrodes 13 can be variously configured depending on the function of the passive component and the like. For example, a portion in which the penetrating electrodes 13 are arranged at equal intervals, a portion in which the penetrating electrodes 13 are not evenly spaced, a portion in which the penetrating electrodes 13 are not arranged over a predetermined section, and the like may be provided.

The outer peripheral portions 11e and 12e of the wide walls 11 and 12 are arranged on the substrate 10. A first dielectric layer 15 is formed on a portion located outside the wide wall 11 on the first surface 10a of the substrate 10. A second dielectric layer 16 is formed on the wide wall 11. In the case of the high-frequency passive component according to the first embodiment shown in FIG. 2, the second dielectric layer 16 is arranged inside the waveguide region 20 in a plan view seen from the thickness direction.

In the following description, the first dielectric layer 15 and the second dielectric layer 16 may be collectively referred to as the dielectric layers 15 and 16. The dielectric layers 15 and 16 may be formed by the same film forming process or may be formed by different film forming processes. Examples of the material forming the dielectric layers 15 and 16 include resins.

The upper conductor layer 14 arranged on the surface of the second dielectric layer 16 reaches the first dielectric layer 15 via the outer peripheral portion 11e of the wide wall 11. The upper conductor layer 14 is disposed on the first surface 10a of the substrate 10 between the wide wall 11 and the first dielectric layer 15. As shown in FIG. 2, the upper conductor layer 14 may have voids 14a such as holes and gaps on the surface of the second dielectric layer 16. When the upper conductor layer 14 is formed on the penetrating electrode 13, the connection portion 14b with the penetrating electrode 13 may be formed in the through hole 13a.

The end portion 14e of the upper conductor layer 14 arranged on the second dielectric layer 16 is arranged at a position apart from the substrate 10 in the thickness direction. The position of the end portion 14e may be arranged on the upper surface of the second dielectric layer 16 along the surface direction of the substrate 10, or on the side surface of the second dielectric layer 16 along the thickness direction of the substrate 10. The upper conductor layer 14 arranged on the second dielectric layer 16 may have pads for external connection. The pad can be composed of a conductor pattern having a width wider than that of the wire. The planar shape of the pad is not particularly limited, and examples thereof include a polygon such as a quadrangle and a circle.

The upper conductor layer 14 is formed over the first dielectric layer 15, the substrate 10 between the first dielectric layer 15 and the wide wall 11, the wide wall 11, and the second dielectric layer 16. Since the upper conductor layer 14 is connected to the wide wall 11, the outer peripheral portion 11e of the large wall 11 having a large area is artificially replaced with the end portion 14e of the upper conductor layer 14 arranged in the first dielectric layer 15. For example, when the film is formed by photolithography, the wide wall 11, the dielectric layers 15 and 16, and the upper conductor layer 14 are stacked in this order. Therefore, the end portion 14e of the upper conductor layer 14 can be arranged on the surface of the first dielectric layer 15 or the surface of the second dielectric layer 16.

According to the high-frequency passive component of the first embodiment, the wide wall 11 can be suppressed from peeling off from the substrate 10 by devising the arrangement of the upper conductor layer 14 and the dielectric layers 15 and 16. The reason for this is not particularly limited to the present invention; however, the following hypothesis can be considered, for example.

When the second dielectric layer 16 is formed on the wide wall 11, the wide wall 11 may be separated from the substrate 10 depending on the usage environment. For example, if the temperature rises or falls drastically, stress is generated between the layers due to the difference in the coefficient of thermal expansion between the material forming the conductor layer of the wide wall 11 and the material forming the dielectric layer 16. Due to the stress, the wide wall 11 may peel off. The peeling of the wide wall 11 occurs from the outer peripheral portion 11e of the wide wall 11 as a starting point.

Therefore, in the present embodiment, the first dielectric layer 15 is provided at a position apart from the wide wall 11, and the end portion 14e of the upper conductor layer 14 is arranged on the surface of the first dielectric layer 15. With this configuration, the stress is relieved via the first dielectric layer 15 without the end portion 14e of the upper conductor layer 14 contacting the substrate 10. Therefore, it is considered that peeling from the end portion 14e of the upper conductor layer 14 is unlikely to occur, and furthermore, since the upper conductor layer 14 covers the outer peripheral portion 11e of the wide wall 11, peeling of the outer peripheral portion 11e of the wide wall 11 is also reduced.

It is preferable that the upper conductor layer 14 be arranged at least at a corner portion of the outer peripheral portion 11e of the wide wall 11 or on the entire outer peripheral portion 11e of the wide wall 11.

In the high-frequency passive component according to the first embodiment shown in FIG. 2, the upper conductor layer 14 is formed over the first dielectric layer 15, the substrate 10 between the first dielectric layer 15 and the wide wall 11, the wide wall 11, and the second dielectric layer 16. However, the upper conductor layer 14 may cover the outer peripheral portion 11e of the wide wall 11. Therefore, the upper conductor layer 14 may be formed over the first dielectric layer 15, the substrate 10 between the first dielectric layer 15 and the wide wall 11, and the wide wall 11. In this case, the second dielectric layer 16 may not be provided on the wide wall 11.

### Second Embodiment

Next, a second embodiment according to the present invention will be described; however, the basic configuration is the same as that of the first embodiment. Therefore, the same reference numerals are given to the same configurations, the description thereof is omitted, and only differences will be described.

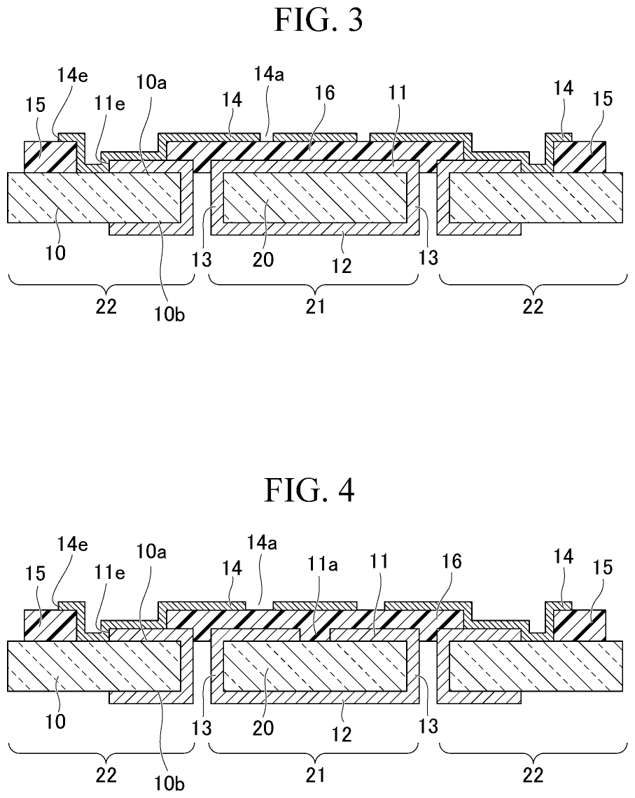

FIG. 3 shows a cross-sectional structure of the high-frequency passive component according to the second embodiment. In the high-frequency passive component of the second embodiment, the second dielectric layer 16 is formed not only on the waveguide region 20 but also on the outer region 22. The second dielectric layer 16 extends over the penetrating electrode 13 and reaches the wide wall 11 in the region 22 outside the waveguide structure 21. The dimension by which the second dielectric layer 16 extends over the penetrating electrode 13 to the outside is not particularly limited; however, may be approximately the same as the diameter of the penetrating electrode 13, for example. Also in the case of the high-frequency passive component of the second embodiment, since the upper conductor layer 14 is provided as in the high-frequency passive component of the first embodiment, it is possible to suppress the wide wall 11 from peeling off from the substrate 10.

### Third Embodiment

Next, a third embodiment according to the present invention will be described; however, the basic configuration is the same as that of the second embodiment. Therefore, the same reference numerals are given to the same configurations, the description thereof is omitted, and only differences will be described.

FIG. 4 shows a cross-sectional structure of the high-frequency passive component of the third embodiment. In the high-frequency passive component of the third embodiment, the wide wall 11 is provided with the opening 11a at a position in contact with the waveguide region 20. Thereby, the mode of the waveguide region 20 and the external mode can be converted through the opening 11a. The position of the opening 11a may be a portion where the second dielectric layer 16 is laminated, or may be a position other than that. Moreover, an opening may be provided in the wide wall 12 of the opposite surface (second surface 10b).

### Fourth Embodiment

Next, a fourth embodiment according to the present invention will be described; however, the basic configuration is the same as that of the third embodiment. Therefore, the same reference numerals are given to the same configurations, the description thereof is omitted, and only differences will be described.

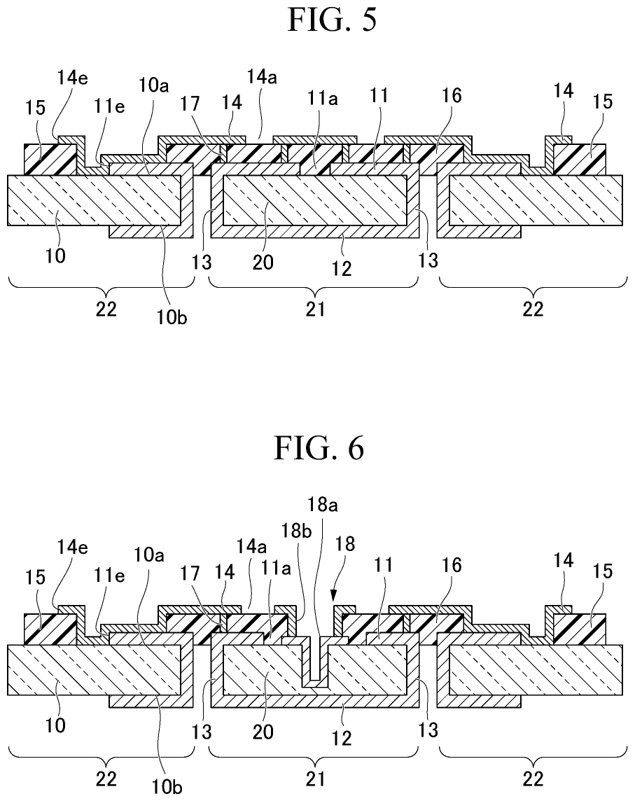

FIG. 5 shows a cross-sectional structure of the high-frequency passive component of the fourth embodiment. The high-frequency passive component of the fourth embodiment has a via 17 formed of a conductor. The via 17 penetrates the second dielectric layer 16 so as to connect the wide wall 11 and the upper conductor layer 14. Thereby, the wide wall 11 and the upper conductor layer 14 can be electrically connected.

### Fifth Embodiment

Next, a fifth embodiment according to the present invention will be described; however, the basic configuration is the same as that of the fourth embodiment. Therefore, the same reference numerals are given to the same configurations, the description thereof is omitted, and only differences will be described.

FIG. 6 shows a cross-sectional structure of the high-frequency passive component of the fifth embodiment. The high-frequency passive component of the fifth embodiment has a mode converter 18. The mode converter 18 includes a conductor (blind via) that does not penetrate the waveguide region 20 of the substrate 10. Thereby, when an electric signal transmission line is provided in the upper conductor layer 14, a signal can be propagated between the transmission line of the upper conductor layer 14 and the waveguide region 20 of the waveguide structure 21.

For example, by radiating the signal propagated from the upper conductor layer 14 to the waveguide region 20 from the mode converter 18, the signal can be propagated to the waveguide structure 21. Furthermore, by causing the mode converter 18 to receive the signal propagating through the waveguide region 20, the signal can be propagated through the transmission line of the upper conductor layer 14. A pin 18a protruding from the opening 11a of the wide wall 11 to the waveguide region 20 is formed at a lower portion of the mode converter 18. A penetrating conductor 18b connected to the upper conductor layer 14 is formed at an upper portion of the mode conversion portion 18.

### Sixth Embodiment

Next, a sixth embodiment according to the present invention will be described; however, the basic configuration is the same as that of the first embodiment. Therefore, the same reference numerals are given to the same configurations, the description thereof is omitted, and only differences will be described.

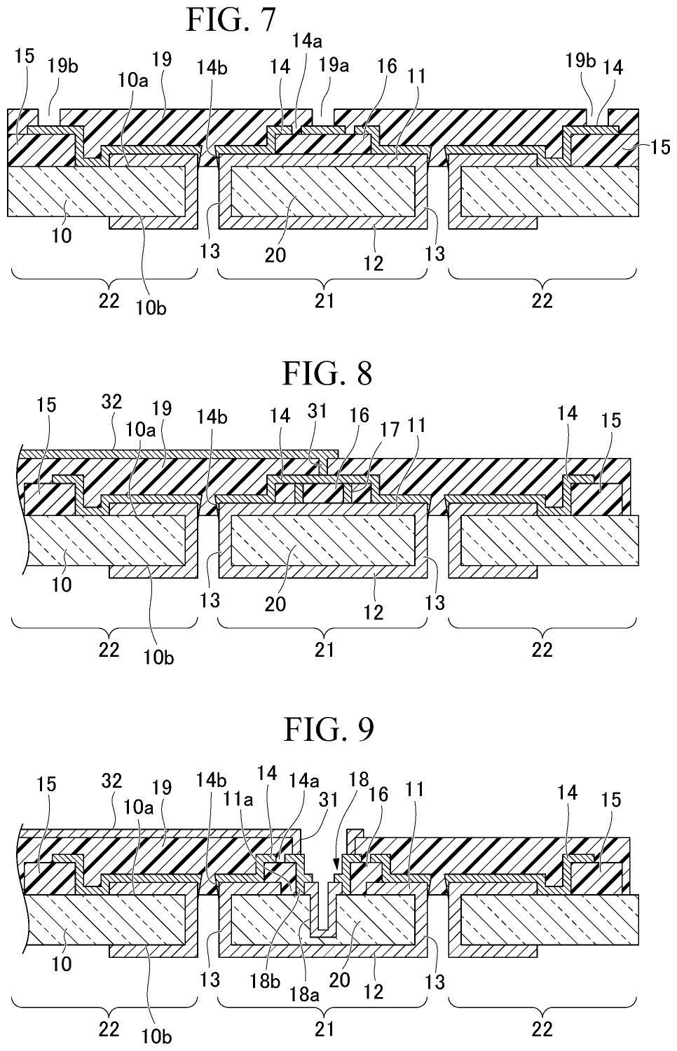

FIG. 7 shows a cross-sectional structure of the high-frequency passive component according to the sixth embodiment. In the high-frequency passive component of the sixth embodiment, the sealing layer 19 formed of resin or the like is laminated on the upper conductor layer 14. The sealing layer 19 may have openings 19a and 19b for external connection, for example. The upper conductor layer 14 may have a pad for external connection in a portion exposed through the openings 19a and 19b.

### Seventh Embodiment

Next, a seventh embodiment according to the present invention will be described; however, the basic configuration is the same as that of the sixth embodiment. Therefore, the same reference numerals are given to the same configurations, the description thereof is omitted, and only differences will be described.

FIG. 8 shows a cross-sectional structure of the high-frequency passive component of the seventh embodiment. In the high-frequency passive component of the seventh embodiment, the wiring layer 32 is provided on the sealing layer 19. The wiring layer 32 and the upper conductor layer 14 are connected by a via 31 penetrating the sealing layer 19. Thereby, an electric signal can be input to the upper conductor layer 14 via the wiring layer 32, or an electric signal can be output from the upper conductor layer 14 via the wiring layer 32. As shown in FIG. 8, the upper conductor layer 14 provided on the second dielectric layer 16 may not have an opening.

### Eighth Embodiment

Next, an eighth embodiment according to the present invention will be described; however, the basic configuration is the same as that of the seventh embodiment. Therefore, the same reference numerals are given to the same configurations, the description thereof is omitted, and only differences will be described.

FIG. 9 shows a cross-sectional structure of the high-frequency passive component according to the eighth embodiment. The high-frequency passive component of the eighth embodiment includes a mode converter 18. The mode converter 18 has a pin 18a and a penetrating conductor 18b. The pin 18a is located at a lower portion of the mode converter 18 and projects into the waveguide region 20. The penetrating conductor 18b is located at an upper portion of the mode converter 18 and is connected to the via 31 of the wiring layer 32.

The pin 18a and the penetrating conductor 18b are electrically connected. Thereby, an electrical signal can be input from the wiring layer 32 to the waveguide region 20 of the waveguide structure 21 via the mode converter 18. Alternatively, an electric signal can be output from the waveguide region 20 of the waveguide structure 21 to the wiring layer 32 via the mode converter 18.

### Ninth Embodiment

Next, a ninth embodiment according to the present invention will be described; however, the basic configuration is the same as that of the seventh embodiment. Therefore, the same reference numerals are given to the same configurations, the description thereof is omitted, and only differences will be described.

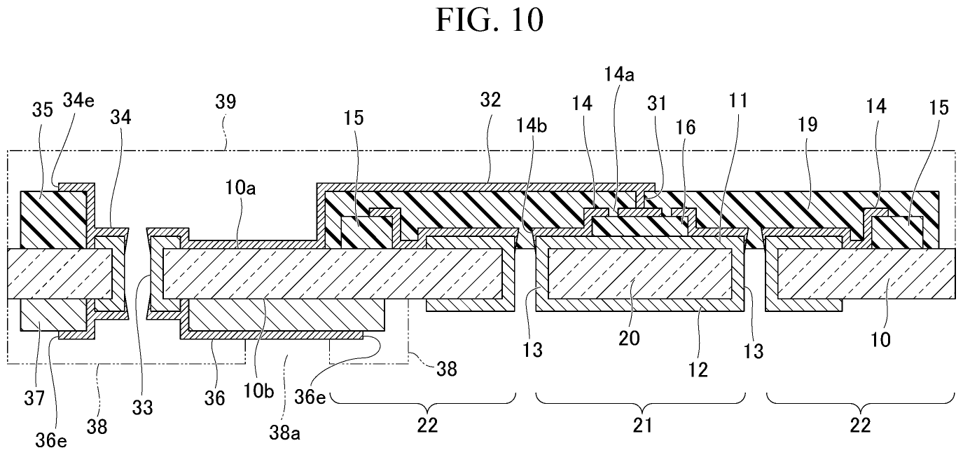

FIG. 10 shows a cross-sectional structure of the high-frequency passive component of the ninth embodiment. The high-frequency passive component of the ninth embodiment has a penetrating structure 33 including penetrating electrodes penetrating both surfaces of the substrate 10 at a position different from the waveguide structure 21. In addition, a third dielectric layer 35 is formed on the first surface 10a of the substrate 10 at a position away from the penetrating structure 33 to the outside. Furthermore, a connection conductor layer 34 electrically connected to the penetrating structure 33 is formed. The connection conductor layer 34 is formed over the penetrating structure 33, the substrate 10 between the penetrating structure 33 and the third dielectric layer 35, and the third dielectric layer 35. The connection conductor layer 34 may be formed integrally with the wiring layer 32.

A third dielectric layer 37 and a connection conductor layer 36 are provided on a side of the second surface 10b of the substrate 10. The third dielectric layer 37 is formed at a position away from the penetrating structure 33 to the outside. The connection conductor layer 36 is electrically connected to the penetrating structure 33. The connection conductor layer 36 may be formed over the penetrating structure 33, the substrate 10 between the penetrating structure 33 and the third dielectric layer 37, and the third dielectric layer 37.

The end portions 34e and 36e of the connection conductor layers 34 and 36 are provided not on the substrate 10 but on the surfaces of the third dielectric layers 35 and 37 formed of resin or the like, so that the third dielectric layer 35 and 37 functions as a stress relaxation layer. Thereby, peeling at the end portions 34e and 36e of the connection conductor layers 34 and 36 can be reduced. In addition, since the end portions 34e and 36e of the connection conductor layers 34 and 36 are all disposed on the third dielectric layers 35 and 37, pattern formation by photolithography or the like is becomes easy.

The connection conductor layers 34 and 36 may be sealed with sealing layers 38 and 39 formed of a dielectric material such as resin, except for the external connection portion and the like. For example, a sealing layer 38 that seals the connection conductor layer 36 may be added, or a sealing layer 39 that seals the connection conductor layer 34 may be added. Both the sealing layer 38 and the sealing layer 39 may be provided.

These sealing layers 38 and 39 may have openings for external connection, for example. The connection conductor layers 34 and 36 exposed by the openings of the sealing layers 38 and 39 may have pads for external connection. Although FIG. 10 shows an example in which the opening 38a is provided in the sealing layer 38, the opening may not be provided in the sealing layer 38. Although no opening is shown in the sealing layer 39, an opening may be provided in the sealing layer 39.

### Tenth Embodiment

Next, a tenth embodiment according to the present invention will be described; however, the basic configuration is the same as that of the first embodiment. Therefore, the same reference numerals are given to the same configurations, the description thereof is omitted, and only differences will be described.

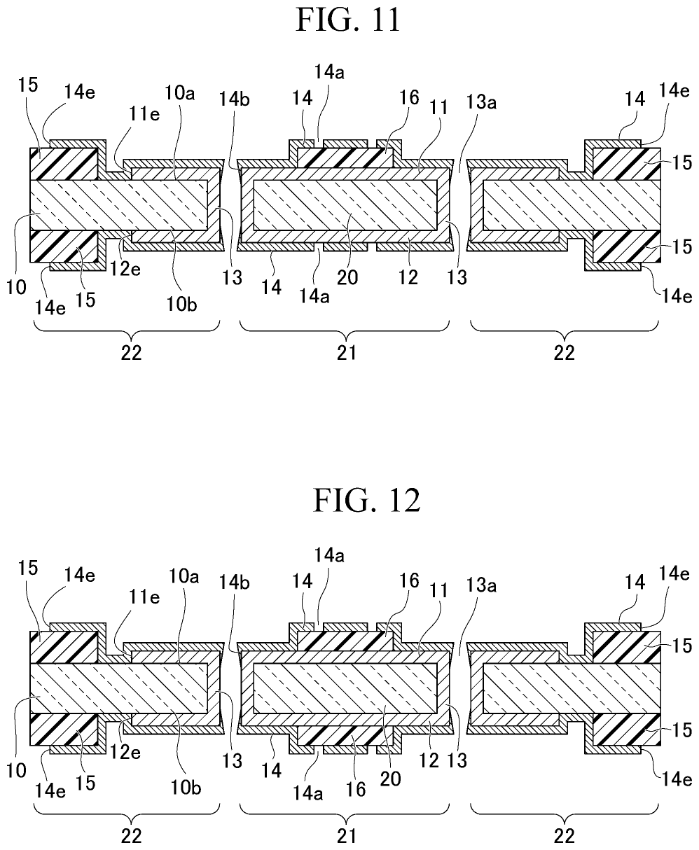

FIG. 11 shows a cross-sectional structure of the high-frequency passive component of the tenth embodiment. In the high-frequency passive component of the tenth embodiment, the first dielectric layer 15 is formed outside the wide walls 11 and 12 on both surfaces (first surface 10a and second surface 10b) of the substrate 10. A second dielectric layer 16 is formed on the wide wall 11. The upper conductor layer 14 is disposed on the second dielectric layer 16 on a side of the first surface 10a. On a side of the second surface 10b, the second dielectric layer 16 is not provided and the upper conductor layer 14 is arranged.

The two upper conductor layers 14 reach the first dielectric layer 15 from the wide walls 11 and 12 through the outer peripheral portions 11e and 12e of the wide walls 11 and 12, respectively. An upper conductor layer 14 is arranged on the substrate 10 between the wide walls 11 and 12 and the first dielectric layer 15. The end portion 14e of each upper conductor layer 14 is arranged at a position apart from the substrate 10 in the thickness direction. In the case of the high-frequency passive component of the tenth embodiment, since the upper conductor layers 14 are provided on the outer peripheral portions 11e and 12e of the wide walls 11 and 12, it is possible to suppress the wide walls 11 and 12 from peeling off from the substrate 10.

### Eleventh Embodiment

Next, an eleventh embodiment according to the present invention will be described; however, the basic configuration is the same as that of the tenth embodiment. Therefore, the same reference numerals are given to the same configurations, the description thereof is omitted, and only differences will be described.

FIG. 12 shows a cross-sectional structure of the high-frequency passive component of the eleventh embodiment. In the high-frequency passive component of the eleventh embodiment, the second dielectric layer 16 is formed not only on the wide wall 11 but also on the wide wall 12. Therefore, also on the side of the wide wall 12, the upper conductor layer 14 is arranged on the second dielectric layer 16. Also in the case of the high-frequency passive component of the eleventh embodiment, the first dielectric layer 15 is formed outside the wide walls 11 and 12 on both surfaces of the substrate 10, and the upper conductor layer 14 is formed similarly to the high-frequency passive component of the tenth embodiment. With this configuration, it is possible to suppress the wide walls 11 and 12 from peeling off from the substrate 10.

### Twelfth Embodiment

Next, a twelfth embodiment of the present invention will be described; however, the basic configuration is the same as that of the eleventh embodiment. Therefore, the same reference numerals are given to the same configurations, the description thereof is omitted, and only differences will be described.

FIG. 13 shows a sectional structure of the high-frequency passive component of the twelfth embodiment. In the high-frequency passive component of the twelfth embodiment, the second dielectric layer 16 is formed not only on the waveguide region 20 but also on the outer region 22 on both surfaces of the substrate 10. The two second dielectric layers 16 extend over the penetrating electrodes 13 and reach the wide walls 11 and 12 in the region 22 outside the waveguide structure 21. The dimension in which the two second dielectric layers 16 extend beyond the penetrating electrode 13 to the outside is not particularly limited; however, may be approximately the same as the diameter of the penetrating electrode 13, for example. Also in the case of the high-frequency passive component of the twelfth embodiment, the first dielectric layer 15 is formed outside the wide walls 11 and 12 on both surfaces of the substrate 10, and the upper conductor layer 14 is provided similarly to the high-frequency passive component of the tenth embodiment. Therefore, peeling of the wide walls 11 and 12 from the substrate 10 can be reduced.

### Thirteenth Embodiment

Next, a thirteenth embodiment according to the present invention will be described; however, the basic configuration is the same as that of the twelfth embodiment. Therefore, the same reference numerals are given to the same configurations, the description thereof is omitted, and only differences will be described.

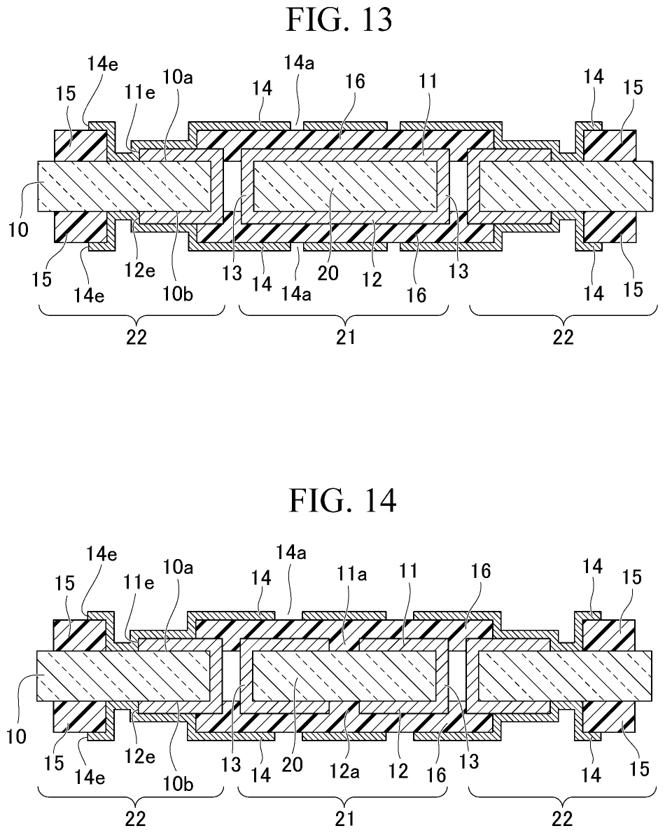

FIG. 14 shows a cross-sectional structure of the high-frequency passive component of the thirteenth embodiment. In the high-frequency passive component of the thirteenth embodiment, openings 11a and 12a are provided in the wide walls 11 and 12 at the positions in contact with the waveguide region 20. Therefore, the mode of the waveguide region 20 and the external mode can be converted through the openings 11a and 12a. The positions of the openings 11a and 12a may be a portion where the second dielectric layer 16 is laminated or may be a position other than that. Also in the case of the high-frequency passive component of the thirteenth embodiment, the first dielectric layer 15 is formed outside the wide walls 11 and 12 on both surfaces of the substrate 10, and the upper conductor layer 14 is provided similarly to the high-frequency passive component of the tenth embodiment. Therefore, peeling of the wide walls 11 and 12 from the substrate 10 can be reduced.

### Fourteenth Embodiment

Next, a fourteenth embodiment according to the present invention will be described; however, the basic configuration is the same as that of the thirteenth embodiment. Therefore, the same reference numerals are given to the same configurations, the description thereof is omitted, and only differences will be described.

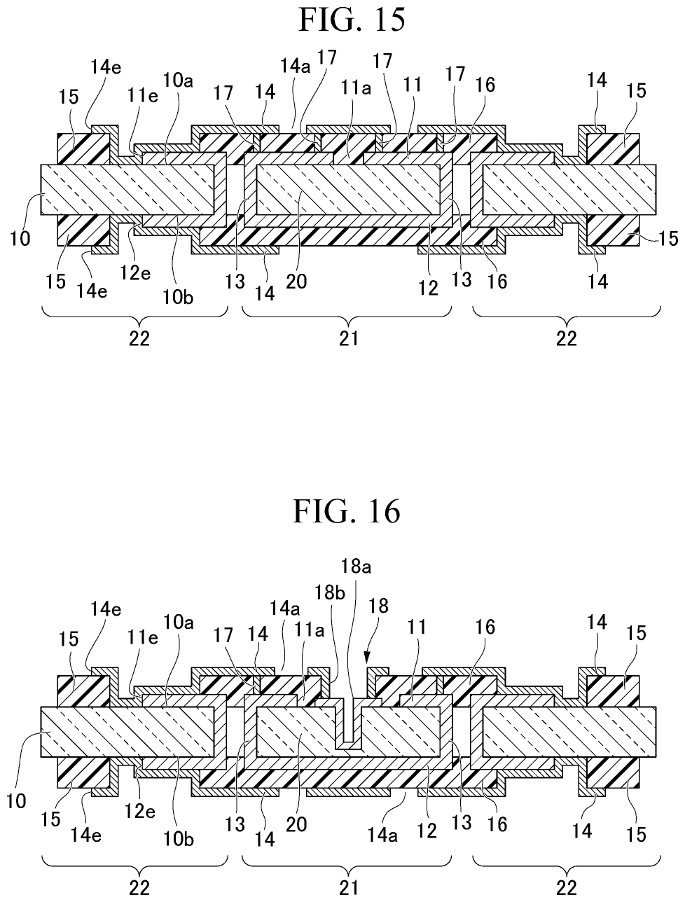

FIG. 15 shows a cross-sectional structure of the high-frequency passive component of the fourteenth embodiment. In the high-frequency passive component of the fourteenth embodiment, a via 17 formed of a conductor penetrating the second dielectric layer 16 is provided so as to connect the wide wall 11 and the upper conductor layer 14. Thereby, the wide wall 11 and the upper conductor layer 14 can be electrically connected. Also in the case of the high-frequency passive component of the fourteenth embodiment, the first dielectric layer 15 is formed outside the wide walls 11 and 12 on both surfaces of the substrate 10, and the upper conductor layer 14 is formed similarly to the high-frequency passive component of the tenth embodiment. Therefore, peeling of the wide walls 11 and 12 from the substrate 10 can be reduced.

### Fifteenth Embodiment

Next, a fifteenth embodiment according to the present invention will be described; however, the basic configuration is the same as that of the fourteenth embodiment. Therefore, the same reference numerals are given to the same configurations, the description thereof is omitted, and only differences will be described.

FIG. 16 shows a cross-sectional structure of the high-frequency passive component according to the fifteenth embodiment. The high-frequency passive component of the fifteenth embodiment has a mode converter 18. The mode converter 18 includes a conductor (blind via) that does not penetrate the waveguide region 20 of the substrate 10. Thereby, when an electric signal transmission line is provided in the upper conductor layer 14, a signal can be propagated between the transmission line of the upper conductor layer 14 and the waveguide region 20 of the waveguide structure 21. Also in the case of the high-frequency passive component of the fifteenth embodiment, the first dielectric layer 15 is formed outside the wide walls 11 and 12 on both surfaces of the substrate 10, and the upper conductor layer 14 is provided similarly to the high-frequency passive component of the tenth embodiment. Therefore, peeling of the wide walls 11 and 12 from the substrate 10 can be reduced.

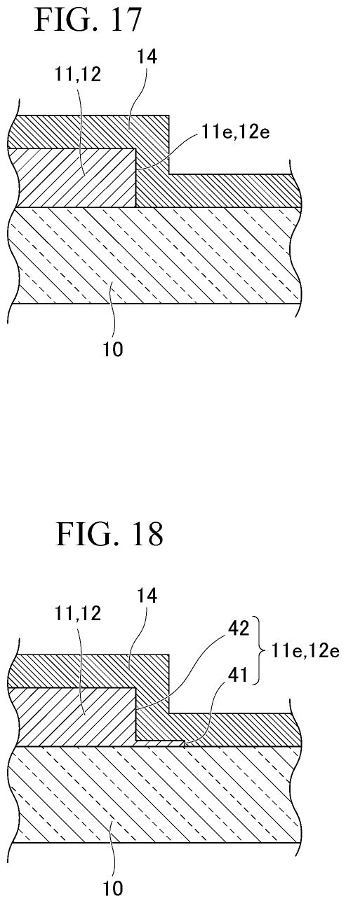

Hereinafter, the configuration of the portion where the upper conductor layer 14 covers the outer peripheral portions 11e and 12e of the wide walls 11 and 12 will be described with reference to FIGS. 17 to 28. FIG. 17 is an enlarged view of a portion (for example, portion A in FIG. 2) where the upper conductor layer 14 covers the outer peripheral portions 11e and 12e. Note that, in FIG. 2 and the like, the upper conductor layer 14 is not provided on the side of the second surface 10b. However, the following description is also applicable to the case where the upper conductor layer 14 is provided on the side of the second surface 10b as shown in FIG. 11. Therefore, as shown in FIG. 17, reference numerals of the wide walls 11 and 12 and the outer peripheral portions 11e and 12e are also described to describe the configurations on both the side of the first surface 10a and the side of the second surface 10b.

As shown in FIG. 17, the upper conductor layer 14 is preferably formed along the surfaces of the outer peripheral portions 11e and 12e of the wide walls 11 and 12. The shape of the side surfaces of the outer peripheral portions 11e and 12e is not limited to the surface perpendicular to the substrate 10 as shown in FIG. 17. For example, the side surfaces of the outer peripheral portions 11e and 12e may be a flat or curved surface or the like so that the widths of the wide walls 11 and 12 increase as the distance from the substrate 10 increases, or so that the widths of the wide walls 11 and 12 decrease as the distance from the substrate 10 increases.

The shapes of the outer peripheral portions 11e and 12e can be formed so that the shape of the end surface of the resist is complementary to the outer peripheral portions 11e and 12e when the pattern of the wide walls 11 and 12 is formed of resist. For example, when the outer peripheral portions 11e and 12e are provided with recess portions, convex portions may be provided on the end surface of the resist. Similarly, when the convex portions are provided on the outer peripheral portions 11e and 12e, the recess portions may be provided on the end surface of the resist.

FIG. 18 shows a first modification example in which the upper conductor layer 14 covers the outer peripheral portions 11e and 12e of the wide walls 11 and 12. In the first modification example, the contact portions 41 and the separation portion 42 are formed on the outer peripheral portions 11e and 12e of the wide walls 11 and 12, respectively. The contact portion 41 is in contact with the substrate 10. The separation portion 42 is separated from the substrate 10 in the thickness direction and is not in contact with the substrate 10. In addition, the contact portion 41 projects from the separation portion 42 toward the outside of the wide walls 11 and 12.

According to the first modification example, since the contact portion 41 is located outside the wide walls 11 and 12 with respect to the separation portion 42, the contact area between the substrate 10 and the wide walls 11 and 12 is large. Furthermore, since the contact portion 41 projects from the separation portion 42, the contact area between the upper conductor layer 14 and the wide walls 11 and 12 also increases. Thereby, the contact area between the substrate 10 and the wide walls 11 and 12 and the contact area between the wide walls 11 and 12 and the upper conductor layer 14 are large as described above, resulting in excellent mutual adhesion. Therefore, the effect of the upper conductor layer 14 reducing the separation of the wide walls 11 and 12 from the substrate 10 can be enhanced.

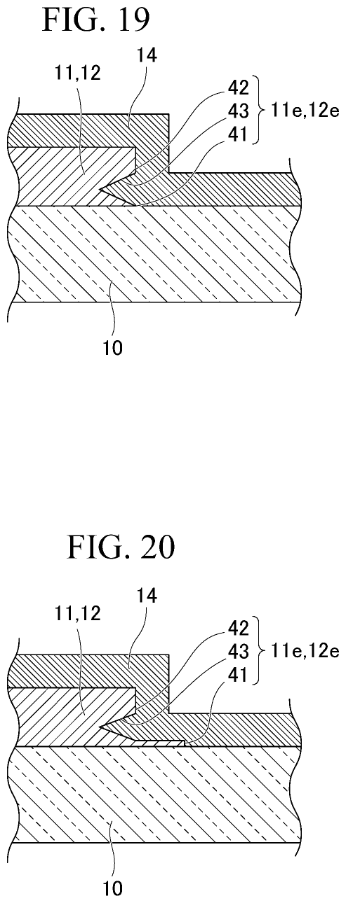

FIG. 19 shows a second modification example in which the upper conductor layer 14 covers the outer peripheral portions 11e and 12e of the wide walls 11 and 12. In the second modification example, the contact portions 41, the separation portions 42, and the recess portions 43 are formed on the outer peripheral portions 11e and 12e of the wide walls 11 and 12, respectively. The contact portion 41 is in contact with the substrate 10. The separating portion 42 is separated from the substrate 10 in the thickness direction and is not in contact with the substrate 10. The recess portion 43 is located between the contact portion 41 and the separation portion 42 and is recessed toward the inside of the wide walls 11 and 12.

The upper conductor layer 14 is formed along the surfaces of the contact portion 41, the separation portion 42, and the recess portion 43. That is, the upper conductor layer 14 has entered the inside of the recess portion 43. Thereby, the contact area between the upper conductor layer 14 and the wide walls 11 and 12 is increased, resulting in excellent mutual adhesion. Therefore, the effect of the upper conductor layer 14 reducing the separation of the wide walls 11 and 12 from the substrate 10 can be enhanced. In the example of FIG. 19, the cross-sectional shape of the recess portion 43 is wedge-shaped (V-shaped) in which the width of the recess portion 43 gradually narrows toward the inside of the wide walls 11 and 12. However, the cross-sectional shape of the recess portion 43 is not limited to this, and may be semicircular, U-shaped, W-shaped, C-shaped, or the like.

FIG. 20 shows a third modification example in which the upper conductor layer 14 covers the outer peripheral portions 11e and 12e of the wide walls 11 and 12. In the third modification example, the contact portions 41, the separation portions 42, and the recess portions 43 are formed on the outer peripheral portions 11e and 12e of the wide walls 11 and 12, respectively. The contact portion 41 is in contact with the substrate 10. The separating portion 42 is separated from the substrate 10 in the thickness direction and is not in contact with the substrate 10. The recess portion 43 is located between the contact portion 41 and the separation portion 42, and is recessed toward the inside of the wide walls 11 and 12. The contact portion 41 is located outside the wide walls 11 and 12 with respect to the separation portion 42.

Thereby, the contact area between the substrate 10 and the wide walls 11 and 12 is increased, and the contact area between the upper conductor layer 14 and the wide walls 11 and 12 is also increased, resulting in excellent mutual adhesion. Therefore, the effect of the upper conductor layer 14 reducing the separation of the wide walls 11 and 12 from the substrate 10 can be enhanced.

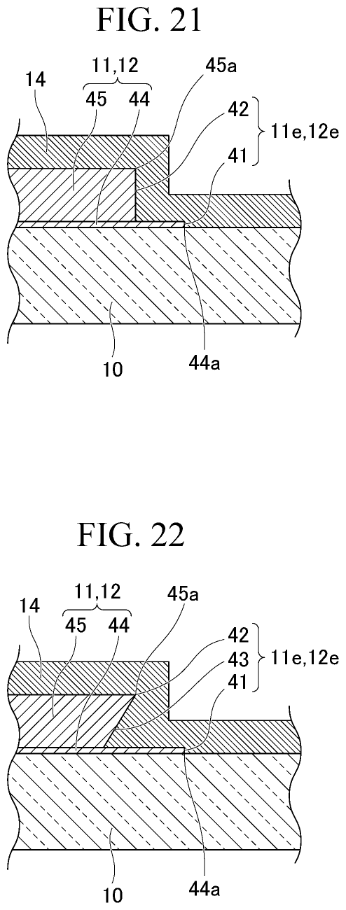

FIG. 21 shows a fourth modification example in which the upper conductor layer 14 covers the outer peripheral portions 11e and 12e of the wide walls 11 and 12. Since the fourth modification example is similar to the first modification example (FIG. 18), the differences will be described. In the fourth modification, the wide walls 11 and 12 includes a first layer 44 that is in contact with the substrate 10 and a second layer 45 that is formed on the first layer 44. In addition, the end portion 44a of the first layer 44 is the contact portion 41 described above. Furthermore, the end portion 45a of the second layer 45 serves as the above-mentioned separation portion 42.

Also in the fourth modification example, the contact area between the substrate 10 and the wide walls 11 and 12 is increased, and the contact area between the upper conductor layer 14 and the wide walls 11 and 12 is increased, resulting in excellent mutual adhesion. Therefore, the effect of the upper conductor layer 14 reducing the separation of the wide walls 11 and 12 from the substrate 10 can be enhanced. The first layer 44 of the wide walls 11 and 12 may be formed by vapor deposition, sputtering, electroless plating of titanium (Ti) or the like, and the second layer 45 of the wide walls 11, 12 may be formed by electrolytic plating of copper (Cu) or the like.

FIG. 22 shows a fifth modification example in which the upper conductor layer 14 covers the outer peripheral portions 11e and 12e of the wide walls 11 and 12. Since the fifth modification example is similar to the third modification example (FIG. 20), the differences will be described. In the fifth modification example, the wide walls 11 and 12 have a first layer 44 that is in contact with the substrate 10 and a second layer 45 formed on the first layer 44. In addition, the end portion 44a of the first layer 44 is the contact portion 41 described above. Furthermore, the end portion 45a of the second layer 45 serves as the above-mentioned separating portion 42 and the recess portion 43.

Regarding the cross-sectional shape of the recess portion 43, the distance from the first layer 44 gradually decreases toward the inner side (inside the wide walls 11 and 12), and the distance from the first layer 44 becomes zero at the innermost side. Thereby, the contact area between the substrate 10 and the wide walls 11 and 12 increases, and the contact area between the upper conductor layer 14 and the wide walls 11 and 12 also increases, resulting in excellent mutual adhesion. Therefore, the effect of the upper conductor layer 14 reducing the separation of the wide walls 11 and 12 from the substrate 10 can be enhanced. However, the cross-sectional shape of the recess portion 43 is not limited to this. The shape of the recess portion 43 is arbitrary as long as the contact area between the first layer 44 and the upper conductor layer 14 is increased.

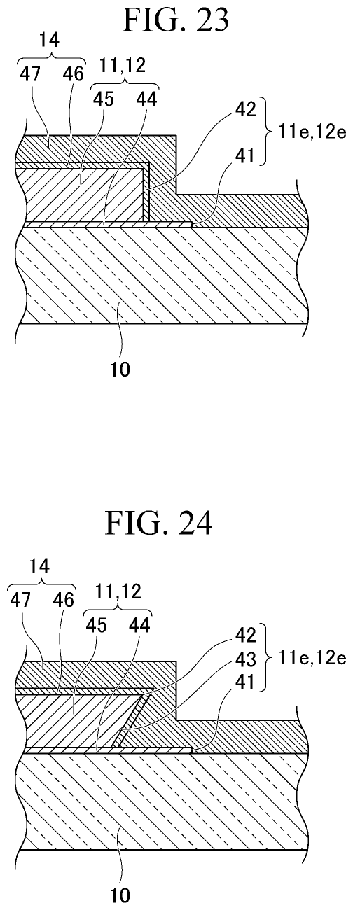

FIG. 23 shows a sixth modification example in which the upper conductor layer 14 covers the outer peripheral portions 11e and 12e of the wide walls 11 and 12. The sixth modification example is similar to the fourth modification example (FIG. 21), and therefore the differences will be described. In the sixth modification example, the upper conductor layer 14 includes a first layer 46 and a second layer 47. The first layer 46 of the upper conductor layer 14 covers the upper surface of the second layer 45 of the wide walls 11 and 12 and the separation portion 42. The second layer 47 of the upper conductor layer 14 covers the entire first layer 46 of the upper conductor layer 14.

FIG. 24 shows a seventh modification example in which the upper conductor layer 14 covers the outer peripheral portions 11e and 12e of the wide walls 11 and 12. The seventh modification example is similar to the fifth modification example (FIG. 22), and therefore the differences will be described. In the seventh modification example, the upper conductor layer 14 has a first layer 46 and a second layer 47. The first layer 46 of the upper conductor layer 14 covers the upper surface of the second layer 45 of the wide walls 11 and 12, the separation portion 42, and the recess portion 43. The second layer 47 of the upper conductor layer 14 covers the entire first layer 46 of the upper conductor layer 14. Both the first layer 46 and the second layer 47 of the upper conductor layer 14 are formed along the surface of the recess portion 43.

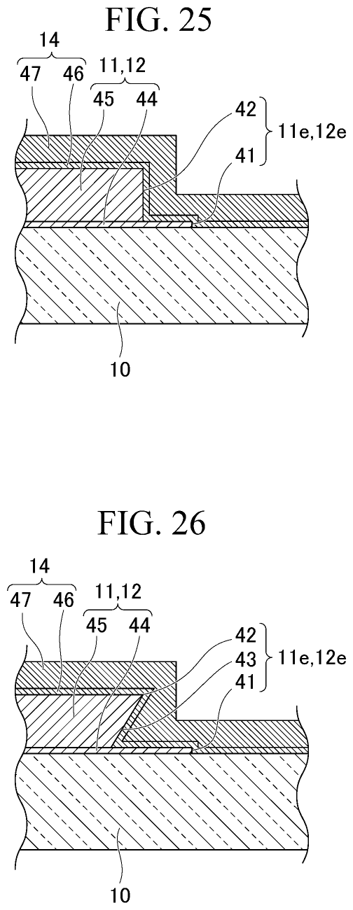

FIG. 25 shows an eighth modification example in which the upper conductor layer 14 covers the outer peripheral portions 11e and 12e of the wide walls 11 and 12. The eighth modification example is similar to the fourth modification example (FIG. 21), and therefore the differences will be described. In the eighth modification, the upper conductor layer 14 includes a first layer 46 and a second layer 47. The first layer 46 of the upper conductor layer 14 covers the upper surface of the second layer 45 of the wide walls 11 and 12, the separating portion 42, the upper surface of the first layer 44 outside the second layer 45, the contact portion 41, and the substrate 10 on the outside of the first layer 44. The second layer 47 of the upper conductor layer 14 covers the entire first layer 46.

FIG. 26 shows a ninth modification example in which the upper conductor layer 14 covers the outer peripheral portions 11e and 12e of the wide walls 11 and 12. The ninth modification example is similar to the fifth modification example (FIG. 22), and therefore the differences will be described. In the ninth modification, the upper conductor layer 14 includes a first layer 46 and a second layer 47. The first layer 46 of the upper conductor layer 14 covers the upper surface of the second layer 45 of the wide walls 11 and 12, the separating portion 42, the recess portion 43, the upper surface of the first layer 44 outside the second layer 45, the contact portion 41, and the top of the substrate 10 outside the first layer 44. The second layer 47 of the upper conductor layer 14 covers the entire first layer 46. Both the first layer 46 and the second layer 47 of the upper conductor layer 14 are formed along the surface of the recess portion 43.

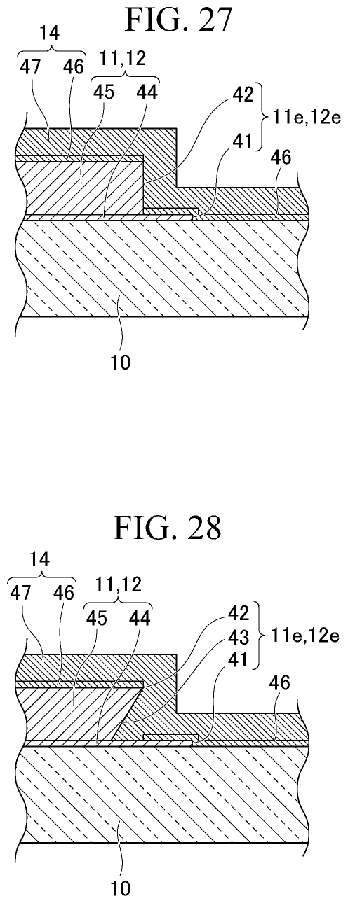

FIG. 27 shows a tenth modification example in which the upper conductor layer 14 covers the outer peripheral portions 11e and 12e of the wide walls 11 and 12. The tenth modification example is similar to the fourth modification example (FIG. 21), and therefore the differences will be described. In the tenth modification, the upper conductor layer 14 has a first layer 46 and a second layer 47. The first layer 46 of the upper conductor layer 14 covers the upper surface of the second layer 45 of the wide walls 11 and 12, the upper surface of the first layer 44 outside the second layer 45, the contact portion 41, and the top of the substrate 10 outside the first layer 44. The second layer 47 of the upper conductor layer 14 covers the entire area covered by the first layer 46 as well as the separation portion 42.

FIG. 28 shows an eleventh modification example in which the upper conductor layer 14 covers the outer peripheral portions 11e and 12e of the wide walls 11 and 12. The eleventh modification example is similar to the fifth modification example (FIG. 22), and therefore the differences will be described. In the eleventh modification, the upper conductor layer 14 includes a first layer 46 and a second layer 47. The first layer 46 of the upper conductor layer 14 covers the upper surface of the second layer 45 of the wide walls 11 and 12 and an area of the upper surfaces of the first layer 44 outside the second layer 45, the area not being underneath the second layer 45 of the wide walls 11 and 12. In addition, the first layer 46 covers the contact portion 41 and the substrate 10 outside the first layer 44. In addition to the entire first layer 46 of the upper conductor layer 14, the second layer 47 of the upper conductor layer 14 covers the separation layer 42 and an area of the upper surfaces of the first layer 44 outside the second layer 45, the area being underneath the second layer 45, and is formed along the surface of the recess portion 43.

In the sixth to eleventh modification examples, the first layer 46 of the upper conductor layer 14 may be formed by vapor deposition of titanium (Ti) or the like, sputtering, electroless plating or the like, and the second layer 47 of the upper conductor layer 14 may be formed by electrolytic plating or the like such as copper (Cu). The second layer 47 of the upper conductor layer 14 may be formed either on the first layer 44 of the wide wall 11 or on the first layer 46 of the upper conductor layer 14. The material forming the first layer 44 of the wide wall 11 and the material forming the first layer 46 of the upper conductor layer 14 may be the same as or different from each other. The material forming the second layer 45 of the wide wall 11 and the material forming the second layer 47 of the upper conductor layer 14 may be the same as or different from each other.

Although the present invention has been described above based on the preferred embodiments, the present invention is not limited to the above-described embodiments, and various modifications can be made without departing from the gist of the present invention. Modifications include addition, replacement, omission, and other changes of the constituent elements in each embodiment. It is also possible to appropriately combine the constituent elements used in the two or more embodiments. That is, the configurations described in the first to fifteenth embodiments and the configurations described in the first to eleventh modification examples may be appropriately combined.

Examples of the method for forming the conductor layer such as the wide wall, the penetrating electrode, and the upper conductor layer include vapor deposition, sputtering, electroless plating, electrolytic plating, and conductor paste. Two or more kinds of conductor materials or film forming methods may be used in combination, and two or more kinds of conductors may be laminated to form a conductor layer. For example, after forming a thin seed layer on the surface of a substrate such as glass, a plating layer having a desired thickness may be laminated on the seed layer.

Examples of the end portion of the conductor layer include the end portion in the longitudinal direction of the wire and the like, the pattern of the pad and the like. The contact surface between the end portion of the conductor layer and the dielectric layer may be parallel, perpendicular, or inclined with respect to the surface direction of the substrate. All the end portions of the conductor layer may be arranged on the dielectric layer.

In the high-frequency passive component according to the above-described embodiment, a plurality of components may be formed on the same substrate. Other components formed on the substrate are not limited to high-frequency passive components; however, may include other passive components, active components, and the like. A high-frequency module can be configured by modularizing the components. The high-frequency module of the present embodiment is, for example, a module including the above high-frequency passive component. The module can incorporate various components necessary for its function.

### DESCRIPTION OF THE REFERENCE SYMBOLS

10: Substrate, 11, 12: Wide wall, 11a, 12a: Wide wall opening, 11e, 12e: Wide wall outer peripheral portion, 13: Penetrating electrode, 13a: Through hole, 14: Upper conductor layer, 20: Waveguide Region, 21: Waveguide structure, 22: Waveguide outer region, 32: Wiring layer, 33: Penetrating structure, 34, 36: Connection conductor layer, 34e, 36e: End portion of connection conductor layer, 35, 37: Third dielectric layer, 41: Contact portion, 42: Separation portion, 43: Recess portion

1. A high-frequency passive component comprising:
a substrate formed of a dielectric material comprising a waveguide region;
a waveguide structure comprising a first wide wall formed on a first surface of the substrate, a second wide wall formed on a second surface of the substrate, and a plurality of penetrating electrodes connected to both of the first and second wide walls, wherein the first wide wall, the second wide wall, and the plurality of penetrating electrodes are arranged so as to surround the waveguide region;
a first dielectric layer formed on the first surface and located outside the first wide wall;
a second dielectric layer formed on the first wide wall; and
an upper conductor layer,
wherein the upper conductor layer is formed over the first dielectric layer, the substrate between the first dielectric layer and the first wide wall, and the first wide wall.

2. The high-frequency passive component according to claim 1, wherein the upper conductor layer is formed over the first dielectric layer, the substrate between the first dielectric layer and the first wide wall, the first wide wall, and the second dielectric layer.

3. The high-frequency passive component according to claim 1, wherein the upper conductor layer is arranged at least at a corner portion of an outer peripheral portion of the first wide wall.

4. The high-frequency passive component according to claim 1, wherein the upper conductor layer is arranged on the entire outer peripheral portion of the first wide wall.

5. The high-frequency passive component according to claim 1, wherein the substrate is formed of glass, and the first dielectric layer and the second dielectric layer are formed of resin.

6. The high-frequency passive component according to claim 1, wherein at least a portion of the upper conductor layer is sealed with a resin.

7. The high-frequency passive component according to claim 1, comprising:
a penetrating structure comprising penetrating electrodes penetrating both surfaces of the substrate at a position different from the waveguide structure;
a third dielectric layer formed on the substrate apart from the penetrating structure; and
a connection conductor layer,
wherein the connection conductor layer is formed over the penetrating structure, the substrate between the penetrating structure and the third dielectric layer, and the third dielectric layer.

8. The high-frequency passive component according to claim 1,
wherein a first dielectric layer located outside the second wide wall and an upper conductor layer are formed on the second surface, and
wherein the upper conductor layer is formed over the first dielectric layer, the substrate between the first dielectric layer and the second wide wall, and the second wide wall.

9. The high-frequency passive components according to claim 1,
wherein a contact portion and a separation portion are formed at an end portion of the first wide wall in a location where the upper conductor layer covers the substrate between the first dielectric layer and the first wide wall and the end portion of the first wide wall,
wherein the separation portion is separated from the substrate, and
wherein the contact portion is in contact with the substrate and is located outside the separation portion.

10. The high-frequency passive component according to claim 1,
wherein a contact portion, a separation portion, and a recess portion are formed at the end portion of the first wide wall in a location where the upper conductor layer covers the substrate between the first dielectric layer and the first wide wall and the end portion of the first wide wall,
wherein the separation portion is separated from the substrate,
wherein the contact portion contacts the substrate,
wherein the recess portion is located between the separation portion and the contact portion, and is recessed toward an inside of the first wide wall, and
wherein the upper conductor layer enters an inside of the recess portion.
